(19) United States
(12) Patent Application Publication
(10) Pub. No.: US 2008/0188295 A1
(43) Pub. Date: Aug. 7, 2008

(54) PROGRESSIVE GAMING DEVICE AND METHOD OF USE

(75) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(73) Assignee: Atlantic City Coin & Slot Service Company, Inc., Pleasantville, NJ (US)

(21) Appl. No.: 12/025,522

(22) Filed: Feb. 4, 2008

Related U.S. Application Data
(60) Provisional application No. 60/888,286, filed on Feb. 5, 2007.

(51) Int. Cl. A63F 13/00

(52) U.S. Cl. 463/27

(57) ABSTRACT

A gaming apparatus includes a gaming device that is adapted to accept a wager and allow a player to play a game. A controller is in communication with the gaming device. The controller maintains a first progressive jackpot and a second progressive jackpot. When a triggering event occurs, at least a portion of the first progressive jackpot is deducted and added to the second progressive jackpot. A gaming method using the gaming apparatus is also disclosed.

### CROSS REFERENCE TO RELATED AND CO-PENDING APPLICATIONS

This patent application claims priority to U.S. Provisional Patent Application Ser. No. 60/888,286, filed on Feb. 5, 2007. The entire contents of which are herein incorporated by reference.

### FIELD OF THE INVENTION

The present invention relates to gaming devices and, more particularly, to a gaming device that provides several progressive jackpots that can change and be funded in several ways.

### BACKGROUND

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (hereinafter, both types are referred to as a “random number”).

The random number can be used to determine a game outcome. For example, the random number may then be compared to a predefined table to determine a corresponding outcome of the event. If the random number falls within a certain range of numbers on the table, the player may win the corresponding predefined prize. The table may also contain display information that allows the gaming device to generate a display that corresponds to the outcome of the game. The gaming device may present the outcome of the game on a large variety of display devices, such as mechanical spinning reels or video screens.

Some gaming devices award bonus prizes in addition to prizes that are awarded in a primary game. Of course, the prize in the primary game may simply be the opportunity to play the bonus game. A bonus prize is generally defined as a prize in addition to the prize obtained from the primary game and that is awarded to the player when a predefined event occurs. An example of a bonus game can be found in U.S. Pat. No. 5,848,932 to Adams. Adams discloses a primary game having three spinning game reels and a bonus game having a bonus display with one spinning wheel. The spinning wheel is divided into multiple sections, and each section has a symbol representing a prize. When predetermined indicia are displayed on the spinning game reels of the primary game, the wheel of the bonus display spins and stops. The bonus prize is displayed as the symbol on the wheel being pointed to by a pointer. The bonus prize is awarded in addition to any prizes awarded in the primary game. Another bonus game is disclosed in Baerlocher et al. (U.S. Pat. No. 6,336,863). Baerlocher et al. discloses a slot machine with a bonus award display. The bonus award display has a bonus wheel and a mechanical, movable pointer.

Gaming devices in casinos are more successful when they are able to captivate and hold a game player's interest for a long period of time. When a game player plays a gaming device for a longer period of time, more revenue is generated for the casino. A game player may lose interest with a game that has a static display that changes very little over time or that they player deems to be unattractive.

One way gaming device manufacturers have added additional enjoyment and excitement to gaming devices is through the advent of progressive gaming. Progressive games have become very popular in casinos. Progressive slot machines contain jackpots that increase every time a player places a wager in a primary game of the slot machine. Progressive jackpots involve one or more gaming machines. For example, an individual progressive slot machine has a self-contained jackpot, wherein the jackpot grows with every play of that machine. A linked progressive includes two or more slot machines at the same or different locations connected to a common jackpot, each of which individually contribute to the jackpot. The gaming machines usually take a percentage of the player's wager, such as 2%, and add it to the progressive jackpot. This allows the progressive jackpot to grow over time. The progressive jackpots can reach sizable amounts, such as multi-million dollar jackpots, before a player “hits” or wins the progressive jackpot.

Large progressive jackpots can be very attractive to casino game players. Furthermore, as the progressive jackpot grows, so does the game's payout percentage because the game pays out more while the likelihood of receiving the progressive award or jackpot remains constant. Players looking to inject skill or strategy into a gaming event therefore look to find progressive games having relatively high progressive jackpots, i.e., games that have not recently paid out. In an effort to further increase the excitement and enjoyment of progressive games and gaming devices in general, it is therefore desirable to inject player interaction, skill, strategy or risk into a progressive gaming device.

Progressive jackpots pay awards very infrequently. The long periods of time between progressive awards causes progressive gaming displays to appear to be very static or slowly changing. Gaming machine players may eventually lose interest in the game and stop playing. This is especially true in casino locations where a large number of linked progressives are located. It can appear to a game player in these locations that there are no winning game players and that the progressive prize will almost never be awarded. A progressive gaming device that has a display that changes parameters and funding of the progressive jackpot game more frequently can increase and prolong player interest.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide game players with a more exciting and desirable gaming experience;

the ability to attract more patrons to play a game;

extend play times and a greater payout possibility for a player;

increase revenues for gaming operators;

provide a gaming device that can fund a secondary progressive jackpot by subtracting a portion of a primary progressive jackpot and adding the subtracted portion to the secondary progressive jackpot;

provide a gaming device that utilizes a visually appealing and highly visible display;

provide a gaming device that may allow a player to see the values of two or more progressive jackpots;

provide a gaming device that may allow a player to win more than one progressive jackpot;

allow a player to see when a progressive jackpot award value may be increased; and

provide a gaming device that uses a timer to display when a progressive jackpot will change value.

These and other advantages may be realized by reference to the remaining portions of the specification, claims, and abstract.

### BRIEF DESCRIPTION OF ONE EMBODIMENT OF THE PRESENT INVENTION

In certain embodiments, the present invention relates to a gaming apparatus that includes a gaming device that is adapted to accept a wager and allow a player to play a game. A controller is in communication with the gaming device. The controller maintains a first progressive jackpot and a second progressive jackpot. When a triggering event occurs, at least a portion of the first progressive jackpot is deducted and added to the second progressive jackpot.

In other embodiments, the present invention relates to a gaming method. According to the method, a player is allowed to place a wager and play a game. A first progressive jackpot having a first award value is funded. The occurrence of a triggering event is detected and a first portion of the first award value is deducted. The first portion is added to a second progressive jackpot. The second progressive jackpot has a second award value.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a front view of a gaming apparatus of the present invention.

FIG. 2 is substantially a schematic diagram of a portion of the gaming apparatus of FIG. 1.

FIG. 3 is substantially a schematic diagram of several of the gaming apparatuses of FIG. 1 connected in a network.

FIG. 4 is substantially a front view of FIG. 1 showing one possible game display.

FIG. 5 is substantially a front view of FIG. 1 showing another possible game display.

FIG. 6 is substantially a flowchart of a gaming method of the present invention.

FIG. 7 is substantially a front view another embodiment of a gaming apparatus in accordance with the present invention.

FIG. 8 is substantially a front view of FIG. 7 showing a possible game display.

### DESCRIPTION OF CERTAIN EMBODIMENTS OF THE PRESENT INVENTION

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Game Apparatus

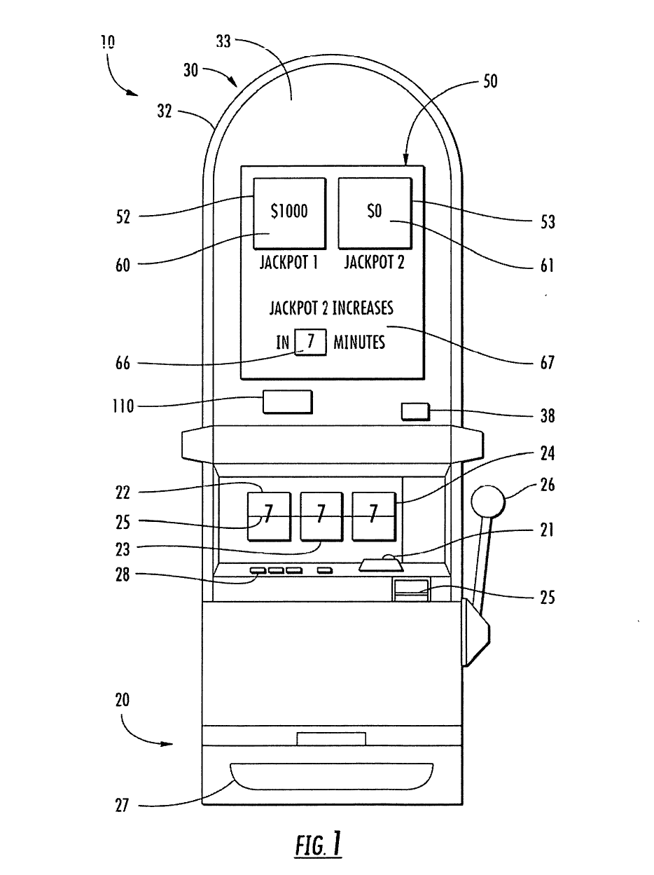

Referring to FIG. 1, one embodiment disclosed herein comprises a gaming apparatus or device, generally indicated by reference number 10. Gaming apparatus 10 comprises a primary gaming device 20 and a bonus or progressive jackpot gaming apparatus or device 30. Progressive jackpot gaming device 30 may comprise a display device 50. Gaming device 20 may be any of a large number of devices that are adapted to allow players to play a game. For example, gaming device 20 may utilize reel displays, such as spinning reels 22-24 and a payline 29 or a video display (not shown), to display outcomes of the game. Means may also be provided for accepting wagers, such as a coin slot 21 or card reader 25, and for awarding prizes, such as a coin dispenser 27. A handle 26 and button 28 are provided for activating gaming device 20 to begin a game. In at least one embodiment, gaming device 20 may be an S Plus model gaming device manufactured by International Game Technology in Reno, Nev.

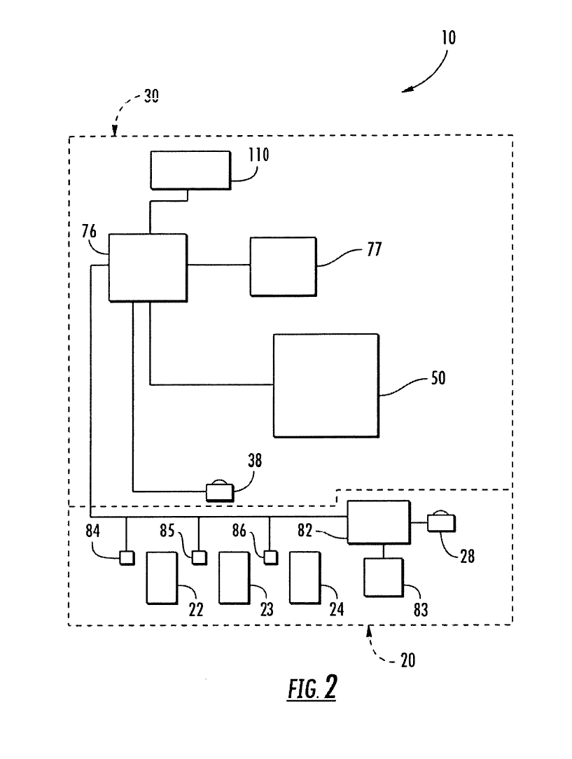

Referring to FIG. 2, gaming device 20 may be controlled by an electronic controller 82 that utilizes a random number generator 83. The random number generator produces a random or pseudo random number for each game. The outcome of the game may be determined by comparing the random number to a table of outcomes stored in a memory and accessed by controller 82. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. Controller 82 causes spinning reels 22-24 of the video display to show the outcome of the game that corresponds to the outcome of the random number generator 83. It is recognized that gaming device 20 may operate in many other ways and still achieve the objects of the present invention.

Gaming device 20 may also be capable of producing a jackpot qualifying or awarding event. This event may be many different types of events. For example, a jackpot qualifying or awarding event may comprise displaying a particular symbol, such as a “bonus” symbol, or combination of symbols, such as three “7” symbols, on reels 22-24 as shown in FIG. 1. If the game being played is poker based, the jackpot qualifying event may be occurrence of a certain hand, such as a royal flush. Furthermore, a jackpot qualifying event may occur when a player accumulates a number of symbols or game outcomes over a number of separate game plays. For example, a jackpot qualifying event may occur when the player receives three “jackpot” symbols during a period of time. The jackpot qualifying event may be based on an external event.

Progressive Jackpot Game

Referring to FIGS. 1 and 2, progressive jackpot game apparatus, progressive jackpot display device or progressive jackpot gaming device 30 may have a housing 32 with a front panel 33. Housing 32 can be made from many different materials such as metal or plastic and can include decorative coverings or attachments and lights. A player input device 38 can be mounted in housing 32. Player input devices 38 can be buttons or handles or rotary knobs. Player input device 38 can allow a game player to provide input to progressive jackpot gaming device 30. A display 110 such as a credit meter can be used to display prizes won on progressive jackpot gaming device 30.

A display 50 such as a video display can be mounted in front panel 33. Display 50 can be any suitable display including video displays, plasma displays, LCD displays, LED meters and the like. Display 50 may be a single display or can be more than one display.

As seen in FIG. 1, display 50 is shown displaying two progressive jackpots. Progressive jackpots 52 and 53 are shown in separate areas of display 50. Alternatively, progressive jackpots 52 and 53 could be shown on separate LED meters. Progressive jackpot 52 is labeled, “Jackpot 1” and progressive jackpot 53 is labeled, “Jackpot 2”.

Progressive jackpots 52 and 53 each have an associated indicia or progressive jackpot award values 60 and 61 that can be awarded to a player as a prize. Progressive jackpot award values 60 and 61 can be a wide variety of awards, such as trips, vouchers, gaming credits, comps for meals or hotels or monetary awards. A game player playing gaming apparatus 10 may be awarded one or both of progressive jackpots 52 and 53. In an embodiment, one or more of award values 60 or 61 may be a hidden or mystery progressive jackpots, wherein the award value of the progressive jackpot is not revealed to the game player until after the progressive jackpot has been won.

Progressive jackpot 52 can be funded in a conventional manner wherein a percentage or portion of the wagers placed on each gaming device 10 is reserved to increase the amount of the progressive jackpot. A portion of each wager is deducted from the wager and added to the progressive jackpot thereby increasing the amount of the progressive jackpot over time until the progressive jackpot is awarded.

While a single gaming apparatus 10 with progressive jackpots 52 and 53 are shown in FIG. 1, it is understood that the progressive jackpots 52 and 53 will also be present in additional linked gaming apparatuses 10 as will be described later. When a large number of gaming apparatuses are linked together, very large progressive jackpots may result.

In one embodiment, a game player may only be allowed to play for one of the progressive jackpots. For example, the game player may only be allowed to win progressive jackpot 52. In another embodiment, progressive jackpots 52 and 53 may be multi-level progressive jackpots that can only be won or awarded in sequence. For example, a player would have to win progressive jackpots 52 first before becoming eligible to play for and win progressive jackpot 53.

In an embodiment, progressive jackpot 52 can be a primary progressive jackpot and progressive jackpot 53 can be a secondary progressive jackpot. Secondary progressive jackpot 53 can be funded from primary progressive jackpot 52. A portion of the award value 60 is deducted or subtracted from progressive jackpot 52 and added to award value 61 of progressive jackpot 53 upon the occurrence of a triggering event or a jackpot funding event as determined by controller 76 (FIG. 2). Secondary progressive jackpot 53 can solely be funded by deducting an amount from progressive jackpot 52 and adding the deducted amount to fund progressive jackpot 53.

The triggering event or jackpot funding event to fund secondary progressive jackpot 53 may be many different kinds of events. The triggering event may be the expiration of a pre-determined time period, the expiration of a random time period, when the primary progressive jackpot 52 reaches a pre-determined award value 60 or when a randomly generated event occurs.

For example, a triggering event may be set to occur when the award value 60 or primary progressive jackpot 52 reaches $775,000. When the award value reaches $775,000, $25,000 may be deducted from award value 60 and be added to award value 61 of secondary progressive jackpot 53. After the triggering event occurs, the primary progressive jackpot 52 will have a new award value of $750,000 and the secondary progressive jackpot 53 will have a new award value of $25,000 assuming that the award value previously was at $0.

In another embodiment, a percentage such as five percent of the primary progressive jackpot 52 may be deducted every hour and added to the secondary progressive jackpot 53.

If the triggering event is time related, a timer or timer display 66 may be a shown on display 50 to indicate when the secondary progressive jackpot 53 may be funded or increased.

An information set 67 may be shown on display 50 to inform a player of how or when secondary progressive jackpot 53 may be funded or change.

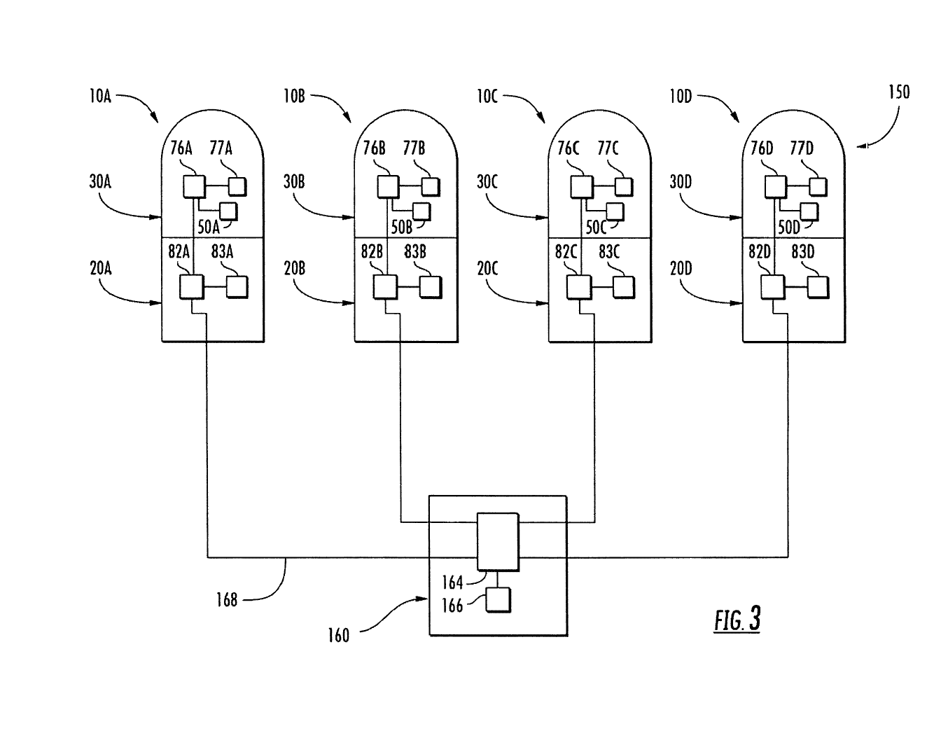

With reference to FIG. 3, a network 150 of gaming apparatuses 10A-D is shown. Network 150 can include several interconnected gaming apparatuses 10A, 10B, 10C and 10D. While four gaming apparatuses are shown, more or less can be used. Gaming apparatuses 10A-D can each have a primary gaming device 20A-D and a progressive jackpot gaming device 30A-D, respectively. Each of primary gaming devices 20A-D can have a controller 82A-D and random number generator 83A-D, respectively.

Gaming devices 10A-D may be in communication with a computer network server 160 through cables 168 such as an Ethernet cable or through a wireless connection. Server 160 can be a conventional network server that contains a memory 166, a controller or processor 164 and software that can operate on the processor.

Server 160 can be connected with other remote networks and other remote gaming devices in remote casinos to form a wide area progressive network that may include hundreds or thousands of gaming devices.

Server 160 can collect and transmit game information and instructions between server 160 and gaming devices 10A-D. For example, server 160 can deduct or apportion a percentage of each wager placed on gaming devices 10A-D to fund progressive jackpot 52. In an embodiment, 1% percent of any wagers placed on gaming devices 10A-D may be deducted from the wager and contributed or added to fund progressive jackpot 52.

Turning now to FIGS. 1, 2 and 3, progressive jackpot gaming device 30 comprises a controller 76 that is adapted to control the operation of the progressive jackpot gaming device. Controller 76 may be one or more micro-computers or processor boards. Random number generator 77 may be in communication with controller 76. Random number generator 77 is capable of randomly generating a random number and providing the random number to controller 76. As shown in FIG. 3, each of progressive jackpot gaming devices 30A-D contains controllers 76A-D and random number generators 77A-D, respectively. Controllers 76A-D are further in communication with and can control displays 50A-D.

It is recognized that controller 76 and random number generator 77 may be a single processor or processor board. Furthermore, it is also recognized that controllers 76 and 82, and random number generators 77 and 83 may be combined in a single processor or processor board. Each of controllers 76A-D may be in communication with server 160 (FIG. 3).

Server 160 and controllers 76A-D can maintain and determine the size of progressive jackpots 52 and 53 (FIG. 1), maintain and determine the amount and method of funding of progressive jackpots 52 and 53 and maintain and determine when secondary progressive jackpot 53 will be funded or increase in value. Server 160 and controllers 76A-D can further cause each of displays 50A-D in gaming devices 10A-D to display progressive jackpots 52 and 53 and their current award values 60 and 61.

In an alternative embodiment, server 160 can control the entire operation of progressive gaming devices 30A-D and controllers 76A-D can be omitted.

Controller 76 is also adapted to detect when a triggering event or jackpot funding event occurs. In an embodiment, controller 76 operates a countdown timer that counts down a pre-determined or a random time period until primary progressive jackpot 52 is reduced and secondary progressive jackpot 53 is funded or increased. Controller 76 may cause the countdown timer 66 to be shown on video display 50. As shown in FIG. 1, countdown timer 66 is showing that 7 minutes remain until progressive jackpot 2 (53) is funded or increases in value.

With continued reference to FIGS. 1, 2 and 3, in another embodiment, controller 82 may determine the outcome of each primary game and when a triggering or jackpot funding event outcome occurs, it transmits a signal to controller 76. For example, when reels 22-24 are in a triggering or jackpot funding event position, controller 76 may cause progressive jackpot 53 to be funded from progressive jackpot 52. The triggering or jackpot funding event position may be a certain combination of symbols on reels 22-24 or may be a special symbol on one of reels 22-24. Controllers 76A-D or 82A-D can each inform server 160 that a triggering or jackpot funding event has occurred in one or more of gaming devices 10A-D.

In one embodiment, server 160 may determine when a triggering or jackpot funding event occurs and transmit a signal to one of controllers 76A-D. For example, server 160 may operate a countdown timer.

When controller 76 detects a triggering or jackpot funding event, it may begin a progressive jackpot funding sequence. The progressive jackpot funding sequence may include activation of various lights and sounds to attract attention to gaming apparatus 10.

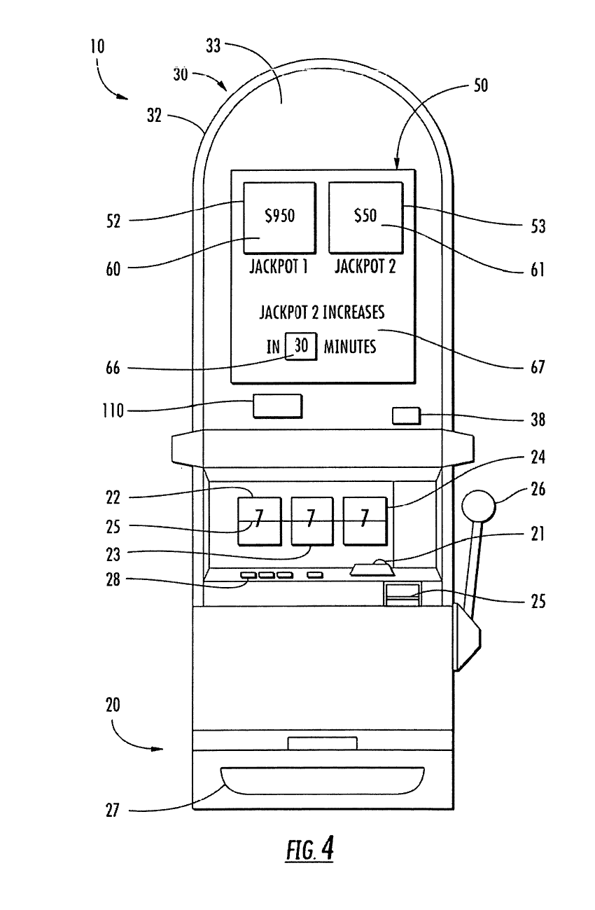

Turning now to FIG. 4, controller 76 (FIG. 2) can contribute a portion of progressive jackpot 52 to progressive jackpot 53. In FIG. 4, $50 has been deducted or subtracted from award value 60 of progressive jackpot 52 and has been added to award value 61 of progressive jackpot 53. FIG. 4 now shows that progressive jackpot 1 (52) has a new award value 60 of “$950” and progressive jackpot 2 (53) has a new award value 61 of “$50”. A game player playing gaming device 10 is now playing for two progressive jackpots.

The controller has also reset countdown timer 66. Countdown timer 66 shows that the next funding of progressive jackpot 53 will occur in 30 minutes. The time period shown by countdown timer 66 may be pre-determined and fixed such as every 30 minutes or may be randomly selected by controller 76 and displayed on countdown timer 66.

In an embodiment, the odds or probability of winning the secondary progressive jackpot 53 are different than the odds or probabilities of winning the primary progressive jackpot 52. For example, secondary progressive jackpot 53 may have a probability of being won once for every 1,000 wagers and primary progressive jackpot 52 may have a probability of being won once for every 25,000 wagers. Secondary progressive jackpot 53 can be awarded more often than primary progressive jackpot 52.

Players playing gaming apparatuses 10A-D will sense that they have an improved or better chance of winning a progressive jackpot because they will be playing for more than one progressive jackpot. In addition, players playing gaming apparatus 10A-D will feel a sense of excitement and anticipation as they view timer display 66 knowing that soon they will be playing for a larger progressive jackpot that is awarded more frequently.

Controller 76 is also adapted to detect when a progressive jackpot awarding or qualifying event occurs in gaming device 20. This may be accomplished by controller 82 transmitting a signal to controller 76 that a progressive jackpot qualifying event has occurred. For example, controller 82 may determine the outcome of each game and when a progressive jackpot qualifying event outcome occurs, it transmits a signal to controller 76. Alternatively, controller 76 may periodically interrogate controller 82. In another embodiment, one or more sensors may be provided for determining if a progressive jackpot qualifying event has occurred. For example, sensors 84-86 may sense the positions of reels 22-24. When reels 22-24 are in a progressive jackpot qualifying event activating position, controller 76 would sense this position and begin a progressive game sequence (described below).

Controllers 76A-D or 82A-D can each inform server 160 that a progressive jackpot qualifying event has occurred in gaming apparatuses 10A-D. Alternatively, server 160 may determine when a jackpot qualifying event occurs and transmit a signal to one of controllers 76A-D.

When controller 76 detects a progressive jackpot qualifying event or is informed of a progressive jackpot qualifying event, it may begin a progressive jackpot sequence by activating display 110. Display 110 may comprise many different kinds of display devices, such as video screens, lights, light emitting diodes, etc. Display 110 may comprise its own controller that is adapted to generate a variety of displays.

Display 110 may indicate that a player has qualified for a progressive jackpot and prompt the player to perform an action. In an embodiment, the player is prompted to start the award sequence by pressing input device 38. Input device 38 may be a simple button, a keyboard, or a touch screen display.

With continued reference to FIGS. 1-4, in an embodiment where either progressive jackpot 52, 53 or both can be awarded, when controller 76 detects input device 38 being activated, controller 76 performs a routine to determine which of the progressive jackpots will be awarded. In an embodiment, the progressive jackpots to be awarded are randomly selected. Random number generator 77 generates a random number and supplies the random number to controller 76. Controller 76 compares the random number to a pay table similar to that described for gaming device 20 or as described in U.S. Pat. No. 5,823,874, issued to Adams. A simple pay table may appear as follows:

TABLE 1

| Random Number | Award |
|---|---|
| 0.00 to 0.05 | Jackpot 1 |
| 0.06 to 0.99 | Jackpot 2 |
| 0.99 to 1.00 | Jackpot 1 and Jackpot 2 |

For example, if the random number generator produced 0.99, progressive jackpots 1 (52) and 2 (53) would be indicated as being won and the award values 60 and 61 contained by progressive jackpots 1 (52) and 2 (53) would be added and awarded to the player. If the random number generator produced 0.32, progressive jackpot 2 (53) would be indicated as being won and the award value 61 contained by progressive jackpot 2 would be awarded to the player. This embodiment is not necessarily limited to the example pay table shown. A larger or fewer number of progressive jackpots may be used. Furthermore, different kinds of prizes may be awarded along with a progressive jackpot. For example, a progressive jackpot and a vacation could be awarded or a progressive jackpot and an award to play additional games could be awarded.

Once controller 76 randomly determines which progressive jackpots are to be awarded, controller 76 causes display 50 to indicate the progressive jackpot or jackpots that have been won. An indicator such as an arrow (not shown) may be illuminated or flashed above the progressive jackpot to be awarded in order for a game player to clearly see what they have won. At the same time, the award values for the progressive jackpot that was not won may be removed from display 50 in order to eliminate any confusion as to which progressive jackpots have been won.

Controller 76 may then cause display 110 to display the total prize, if any, that the player has won. The amount of each progressive jackpot won may be added by controller 76 and then shown on display 110. Other effects may also be presented, such as pre-recorded sound from speakers. If the actual prize is money, the amount of the prize may be added to the player's credit meter or dispensed.

After controller 76 randomly determines which progressive jackpots are to be awarded, controller 76 informs server 160 of the progressive jackpots awards. Server 160 then updates displays 50A-D on each of gaming devices 10A-D with at least one new progressive award value. For example, primary progressive jackpot 52 on displays 50A-D maybe set to zero and would then start accumulating value as the primary progressive jackpot is funded through a portion of wagers from game play on primary gaming devices 20A-D.

It is also possible to replace the primary display of a gaming device with bonus gaming device 30. In other words bonus gaming device 30 can also be used as a primary or base game apparatus.

Gaming apparatus 10 may also be used with multi-level progressive jackpots. In a multi-level progressive jackpot game, several progressive jackpots are provided that are in a particular order and game players must win each jackpot in sequence before they are eligible to win the next progressive jackpot.

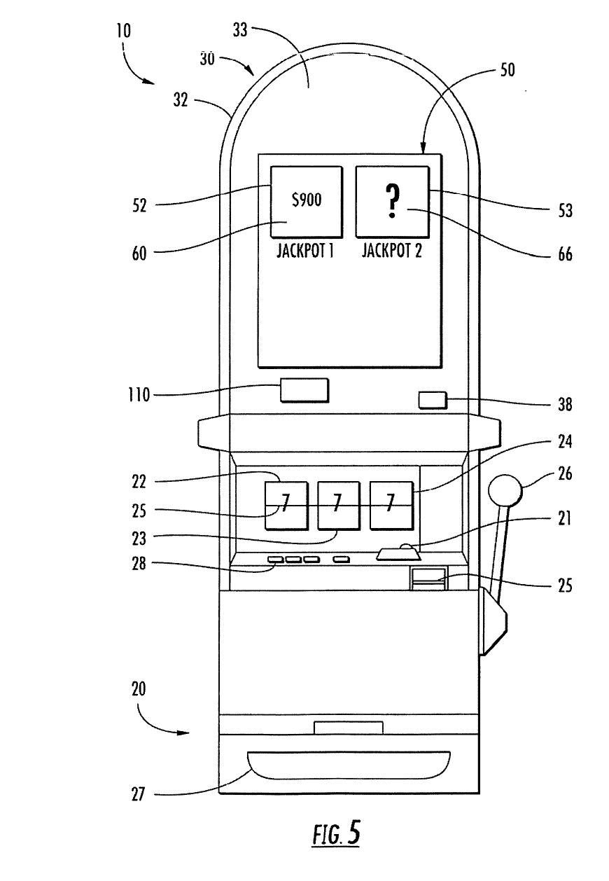

Turning now to FIG. 5, in an embodiment, secondary progressive jackpot 53 may be a hidden or mystery jackpot with a hidden or mystery award value 66. The award value 66 is not revealed to a game player until after secondary progressive jackpot 53 has been won. Secondary progressive jackpot 53 may be funded after a triggering event in the same manner previously described in FIGS. 1-4.

Game Method

Referring now to FIGS. 1, 2 and 6, a flowchart of a method of game play 200 using gaming apparatuses 10 and network 150 (FIG. 3) is shown. At step 202, a player may initiate game play method 200 by placing a wager on one of gaming apparatuses 10. The wager may be in form of cash or credit from actual domestic or foreign currency, vouchers, coupons, tickets, electronic cards, and other sources or forms of wagers known in the art. Once the player initiates game play, the primary game random number generator generates a first random number and randomly determines the base game outcome at step 203. Next, the player may play a base or primary gaming device 20 at step 204.

At decision step 210, the controller checks for or detects the occurrence of a triggering or secondary progressive jackpot funding event. In one embodiment, the triggering or jackpot funding event may be the expiration of a time period shown on timer 66. If the controller does not detect a triggering or jackpot funding event, method 200 proceeds to decision 218.

If the controller detects that a triggering or jackpot funding event has occurred at decision step 210, method 200 proceeds to step 212 where the amount to fund secondary progressive jackpot 53 is determined. At step 214, the primary progressive jackpot 52 award value 60 is reduced by the amount to be added to secondary progressive jackpot 53. The amount deducted from primary progressive jackpot 52 is added to secondary progressive jackpot 53. The new award values 60 and 61 of primary and secondary progressive jackpots 52 and 53, respectively are shown on display 50 in step 216. At step 217, countdown timer 66 can be reset to a new time period. Method 200 then proceeds to decision 218.

At decision 218, the controller checks for the occurrence of a jackpot qualifying or awarding event. If the controller does not detect a jackpot awarding event, method 200 proceeds to step 222 where the primary progressive jackpot 52 funding is determined.

If the controller detects a jackpot awarding event at decision step 218, controller 76 or server 160 determines which of the progressive jackpots are to be awarded at step 219 and displays and awards any progressive jackpot prizes at step 220. The primary progressive jackpot, the secondary progressive jackpot or both the primary and secondary progressive jackpots may be awarded as a prize to the game player.

Next method 200 proceeds to step 222 where funding of primary progressive jackpot 52 is determined. Step 222 may include apportioning a percentage of the wagers on primary gaming devices 20A-D and determining the percentage to apportion. After the primary progressive jackpot funding is determined in step 222, the primary progressive jackpot 52 is incremented in step 224.

Next, the controller notifies the player of the game outcome from the base game at step 208. Method 200 then returns to step 202 where the player may place another wager and play one of gaming apparatuses 10 again.

The steps shown in the flowchart do not necessarily imply that the steps have to take place in a particular order. The order of steps may be varied; some steps may be eliminated; and, some steps may be replaced with other steps. Such variations still fall within the scope of the invention.

Progressive Jackpot Game Using Three or More Progressive Jackpots

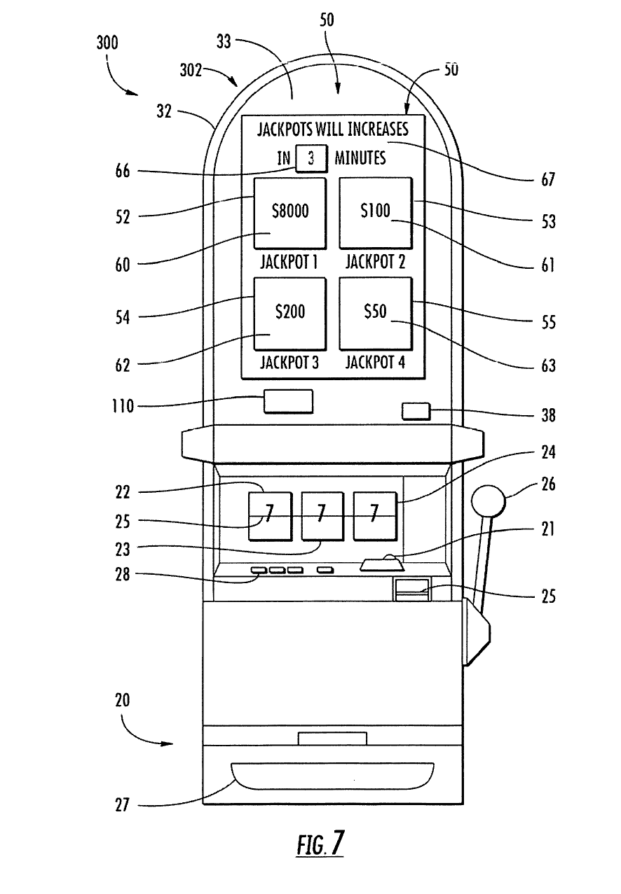

With reference now to FIG. 7, another embodiment of a gaming apparatus 300 in accordance with the present invention is shown. Gaming apparatus 300 is similar to gaming apparatuses 10 except that instead of two progressive jackpots, gaming apparatus 300 has four progressive jackpots. One of the progressive jackpots can be a primary progressive jackpot and three can be secondary progressive jackpots.

Gaming apparatus 300 has a primary or base gaming device 20 and a progressive jackpot gaming device 302. Progressive jackpot gaming device 302 has a video display 50 that is shown displaying four progressive jackpots. Progressive jackpots 52, 53, 54 and 55 are shown in separate areas of display 50. Alternatively, progressive jackpots 52-55 could be shown on separate LED meters or separate video displays. Several gaming apparatuses 300 may be connected in a network of gaming apparatuses 150 (FIG. 3) in the same manner previously described for gaming apparatuses 10A-D.

Primary progressive jackpot 52 is labeled, “Jackpot 1”, secondary progressive jackpot 53 is labeled, “Jackpot 2”, secondary progressive jackpot 54 is labeled, “Jackpot 3” and secondary progressive jackpot 55 is labeled, “Jackpot 4”. Progressive Jackpots 52-55 each have an associated progressive jackpot award value that can be awarded to a player as a prize. Primary progressive jackpot 52 has an award value 60 shown as, “$8000”. Secondary progressive jackpot 53 has an award value 61 shown as, “$100”. Secondary progressive jackpot 54 has an award value 62 shown as, “$200”. Secondary progressive jackpot 55 has an award value 63 shown as, “$50”.

A game player playing gaming apparatus 300 may be awarded one, two, three or all of progressive jackpots 52-55. In an embodiment, one or more of award values 60-63 may be a hidden or mystery progressive jackpots wherein the award value of the progressive jackpot is not revealed to the game player until after the progressive jackpot has been won.

Primary progressive Jackpot 52 can be funded in a conventional manner wherein a percentage or portion of the wagers placed on each gaming device 300 is reserved to increase the amount of primary progressive jackpot 52. A portion of each wager is deducted from the wager and added to the primary progressive jackpot 52 thereby increasing the amount of the primary progressive jackpot over time.

Secondary progressive jackpots 53, 54 and 55 may be funded upon the occurrence of triggering or jackpot funding event as determined by controller 76 (FIG. 2) or server 160 (FIG. 3).

In one embodiment, a game player may only be allowed to play for one of the progressive jackpots. For example, the game player may only be allowed to win progressive jackpot 54. In another embodiment, progressive jackpots 52-55 may be multi-level progressive jackpots that can only be won or awarded in sequence.

In an embodiment, progressive jackpot 52 can be a primary progressive jackpot and progressive jackpots 53-55 can be alternate or secondary progressive jackpots. Secondary progressive jackpots 53, 54 and 55 can be funded from primary progressive jackpot 52. A portion of the award value 60 is deducted or subtracted from primary progressive jackpot 52 and added to the award values 61, 62 and 63 of secondary progressive jackpots 53, 54 and 55 upon the occurence of a triggering event or a jackpot funding event as determined by controller 76 (FIG. 2). Secondary progressive jackpots 53-55 can be funded by deducting an amount from progressive jackpot 52 and adding the deducted amount to fund progressive jackpots 53-55.

The triggering event or jackpot funding event to fund secondary progressive jackpots 53-55 may be many different kinds of events. The triggering event may be the expiration of a pre-determined time period, the expiration of a random time period, when the primary progressive jackpot 52 reaches a pre-determined award value 60 or when a randomly generated event occurs.

In one embodiment, a fixed percentage such as five percent of the primary progressive jackpot 52 may be deducted every hour and be distributed equally among the secondary progressive jackpots 53-55.

In another embodiment, a randomly selected percentage of the primary progressive jackpot 52 may be deducted every hour and be distributed equally among the secondary progressive jackpots 53-55.

In an additional embodiment, a fixed percentage such as five percent of the primary progressive jackpot 52 may be deducted every hour and then be randomly distributed to one of the secondary progressive jackpots 53-55.

If the triggering event is time related, a timer or timer display 66 may be a shown on display 50 to indicate when the secondary progressive jackpots 53-55 may be funded or increased.

An information set 67 may be shown on display 50 to inform a player of how or when the secondary progressive jackpots 53-55 may be funded or change.

Controller 76 (FIG. 2) is also adapted to detect when a triggering event or jackpot funding event occurs. In an embodiment, controller 76 operates a countdown timer that counts down a pre-determined or a random time period until primary progressive jackpot 52 is reduced and secondary progressive jackpots 53-55 are funded or increased. Controller 76 may cause the countdown timer 66 to be shown on video display 50. As shown in FIG. 7, countdown timer 66 is showing that 3 minutes remain until the secondary progressive jackpots 53-55 are funded or increase in value.

In one embodiment, server 160 (FIG. 3) may determine when a triggering or jackpot funding event occurs and transmit a signal to one of controllers 76A-D (FIG. 3). For example, server 160 may operate a countdown timer.

When controller 76 detects a triggering or secondary progressive jackpot funding event, it may begin a progressive jackpot funding sequence. The progressive jackpot funding sequence may include activation of various lights and sounds to attract attention to gaming apparatus 300.

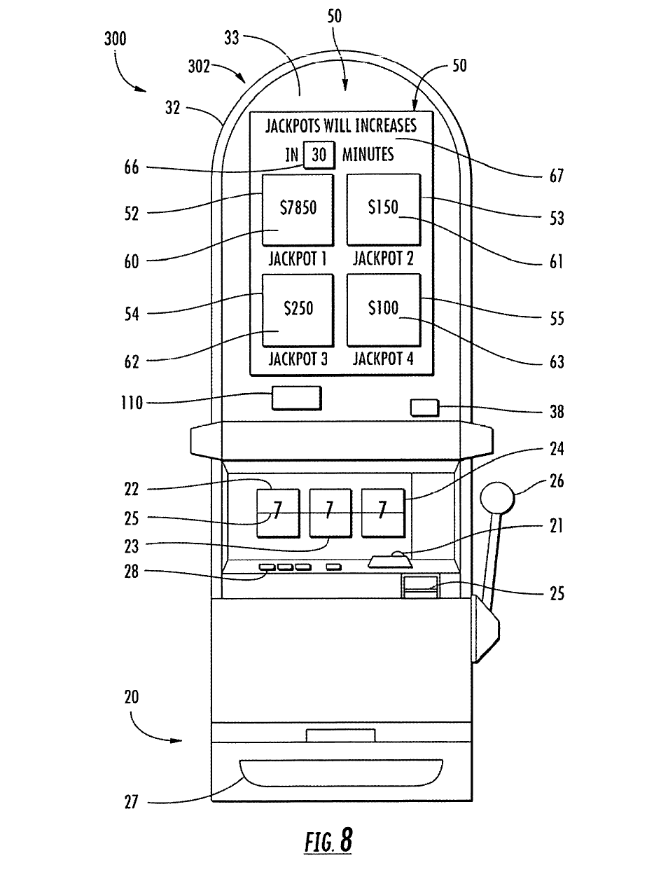

Turning now to FIG. 8, controller 76 (FIG. 2) can contribute a portion of primary progressive jackpot 52 to secondary progressive jackpots 53-55 during the progressive jackpot funding sequence. In FIG. 8, $150 has been deducted or subtracted from award value 60 of progressive jackpot 52 and has been added in equal amounts of $50 to each to secondary progressive jackpots 53, 54 and 55. FIG. 8 now shows that primary progressive jackpot 1 (52) has a new award value 60 of “$7850”, secondary progressive jackpot 2 (53) has a new award value 61 of “$150”, secondary progressive jackpot 3 (54) has a new award value 62 of “$250” and secondary progressive jackpot 4 (55) has a new award value 63 of “$100”.

Controller 76 has also reset countdown timer 66. Countdown timer 66 shows that the next funding of secondary progressive jackpots 53-55 will occur in 30 minutes. The time period shown by countdown timer 66 may be pre-determined and fixed such as every 30 minutes or may be randomly selected by controller 76 and displayed on countdown timer 66.

In an embodiment, the odds or probability of winnings the secondary progressive jackpots 53-55 are different than the odds or probabilities of winning the primary progressive jackpot 52. For example, secondary progressive jackpot 53 may have a probability of being won once for every 1,000 wagers, secondary progressive jackpot 54 may have a probability of being won once for every 2,500 wagers, secondary progressive jackpot 55 may have a probability of being won once for every 5,000 wagers and primary progressive jackpot 52 may have a probability of being won once for every 25,000 wagers. Secondary progressive jackpots 53, 54 and 55 can be awarded more often than primary progressive jackpot 52.

Players playing gaming apparatuses 300A-D will sense that they have an improved or better chance of winning a progressive jackpot because they will be playing for more than one progressive jackpot with improved odds. In addition, players playing gaming apparatuses 10A-D will feel a sense of excitement and anticipation as they view timer display 66 knowing that soon they will be playing for larger progressive jackpots that are awarded more frequently.

Server 160 and controller 76 are adapted to create and maintain progressive jackpots 52-55 of gaming apparatus 300.

With reference to FIGS. 2, 3 and 8, controller 76 or server 160 is also adapted to detect when a progressive jackpot awarding or qualifying event occurs in gaming device 20. This may be accomplished by controller 82 transmitting a signal to controller 76 that a progressive jackpot qualifying event has occurred. For example, controller 82 may randomly determine the outcome of each game using a random number generator and when a progressive jackpot qualifying event outcome occurs, it transmits a signal to controller 76. Alternatively, controller 76 may periodically interrogate controller 82. In another embodiment, one or more sensors may be provided for determining if a progressive jackpot qualifying event has occurred. For example, sensors 84-86 may sense the positions of reels 22-24. When reels 22-24 are in a progressive jackpot qualifying event activating position, controller 76 would sense this position and begin a progressive game sequence (described below).

Controllers 76A-D or 82A-D can each inform server 160 that a progressive jackpot qualifying event has occurred in one of gaming apparatuses 300 connected in a network 150. Alternatively, server 160 may randomly determine when a jackpot qualifying event occurs and transmit a signal to one of controllers 76A-D. Server 160 may use a random number generator to randomly determine when a jackpot qualifying or awarding event occurs.

When controller 76 detects a progressive jackpot qualifying event or is informed of a progressive jackpot qualifying event, it may begin a progressive jackpot sequence by activating display 110. Display 110 may comprise many different kinds of display devices, such as video screens, lights, light emitting diodes, etc. Display 110 may comprise its own controller that is adapted to generate a variety of displays.

Display 110 may indicate that a player has qualified for a progressive jackpot and prompt the player to perform an action. In an embodiment, the player is prompted to start the award sequence by pressing input device 38. Input device 38 may be a simple button, a keyboard, or a touch screen display.

In an embodiment either one of progressive jackpots 52, 53, 54, 55, a combination of progressive jackpots 52-55 or all of progressive jackpots 52-55 can be awarded. When controller 76 detects input device 38 being activated, controller 76 performs a routine to determine which of the progressive jackpots will be awarded. In an embodiment, the progressive jackpots to be awarded are randomly selected. Random number generator 77 generates a random number and supplies the random number to controller 76. Controller 76 compares the random number to a pay table similar to that described for gaming device 20 or as described in U.S. Pat. No. 5,823,874, issued to Adams. A simple pay table may appear as follows:

TABLE 1

| Random Number | Award |
|---|---|
| 0.00 to 0.05 | Jackpot 1 |
| 0.06 to 0.35 | Jackpot 2 |
| 0.36 to 0.65 | Jackpot 3 |
| 0.66 to 0.90 | Jackpot 4 |
| 0.91 to 0.92 | Jackpots 1 and 2 |
| 0.93 to 0.94 | Jackpots 2 and 3 |
| 0.95 to 0.96 | Jackpots 3 and 4 |
| 0.96 to 0.97 | Jackpots 1 and 4 |
| 0.97 to 0.98 | Jackpots 2 and 4 |
| 0.98 to 0.985 | Jackpots 1, 2 and 3 |
| 0.985 to 0.99 | Jackpots 1, 3 and 4 |
| 0.99 to 0.999 | Jackpots 2, 3 and 4 |
| 0.999 to 1.00 | Jackpots 1, 2, 3 and 4 |

For example, if the random number generator produced 0.999, progressive jackpots 1-4 (52-55) would be indicated as being won and the award values 60, 61, 62 and 63 contained by progressive jackpots 52-55 would be added and awarded to the player.

If the random number generator produced 0.32, progressive jackpot 2 (53) would be indicated as being won and the award value 61 contained by progressive jackpot 2 would be awarded to the player. This embodiment is not necessarily limited to the example pay table shown. A larger or fewer number of progressive jackpots may be used.

Once controller 76 randomly determines which progressive jackpots are to be awarded, controller 76 causes display 50 to indicate the progressive jackpot or jackpots that have been won. An indicator such as an arrow (not shown) may be illuminated or flashed above the progressive jackpots to be awarded in order for a game player to clearly see what they have won. At the same time, the award values for the progressive jackpots that were not won may be removed from display 50 in order to eliminate any confusion as to which progressive jackpots have been won.

Controller 76 may then cause display 110 to display the total prize, if any, that the player has won. The amount of each progressive jackpot won may be added by controller 76 and then shown on display 110. Other effects may also be presented, such as pre-recorded sound from speakers. If the actual prize is money, the amount of the prize may be added to the player's credit meter or dispensed.

Gaming apparatus 300 may also be used with multi-level progressive jackpots. In a multi-level progressive jackpot game, several progressive jackpots are provided that are in a particular order and game players must win each jackpot in sequence before they are eligible to win the next progressive jackpot.

In another embodiment, gaming apparatus 300 may fund each of the progressive jackpots in sequence. Progressive jackpot 52 can be a primary progressive jackpot, progressive jackpot 53 can be secondary progressive jackpot, progressive jackpot 54 can be tertiary progressive jackpot and progressive jackpot 55 can be quaternary progressive jackpot.

Progressive jackpot 53 is funded from progressive jackpot 52. Progressive jackpot 54 is funded from progressive jackpot 53 and progressive jackpot 55 is funded from progressive jackpot 54.

A portion of the award values 60-62 are deducted or subtracted from progressive jackpots 52, 53 and 54 and added to the respective award values 61, 62 and 63 of progressive jackpots 53, 54 and 55 upon the occurrence of a triggering event or a jackpot funding event as determined by controller 76. With this embodiment, progressive jackpot 55 would have a small value, progressive jackpot 54 a medium value and progressive jackpot 53 a large value. Primary progressive jackpot 52 would still have the largest value.

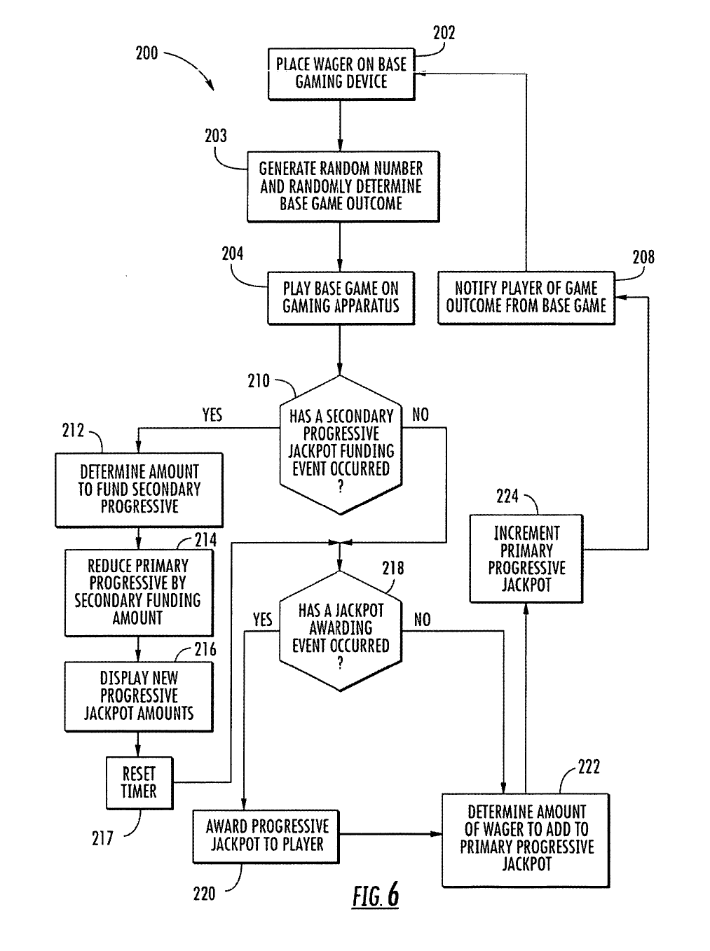

Gaming apparatus 300 can be played using the same method previously described for gaming apparatus 10 in FIG. 6.

Conclusion

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A gaming apparatus comprising:
(A) at least one gaming device that is adapted to accept a wager and allow a player to play a game; and
(B) a controller in communication with the gaming device, the controller being adapted to maintain a first progressive jackpot and a second progressive jackpot, wherein upon the occurrence of a triggering event, at least a portion of the first progressive jackpot is deducted and added to the second progressive jackpot.

2. The gaming apparatus of claim 1, wherein the triggering event is the expiration of a time period.

3. The gaming apparatus of claim 1, wherein the triggering event occurs randomly.

4. The gaming apparatus of claim 1, wherein the triggering event occurs when the first progressive jackpot reaches a pre-determined award value.

5. The gaming apparatus of claim 1, wherein at least one of the progressive jackpots has a hidden award value.

6. The gaming apparatus of claim 1, wherein the controller is adapted to maintain a third progressive jackpot, wherein upon the occurrence of a triggering event, at least a portion of the second progressive jackpot is deducted and added to the third progressive jackpot.

7. A method of gaming, comprising, not all necessarily in the order shown:
(A) allowing a player to place a wager and play a game;
(B) funding a first progressive jackpot having a first award value;
(C) detecting the occurrence of a triggering event;
(D) deducting a first portion of the first award value; and
(E) adding the first portion to a second progressive jackpot, the second progressive jackpot having a second award value.

8. The method of claim 7, wherein the triggering event is the expiration of a time period.

9. The method of claim 7, wherein the triggering event occurs randomly.

10. The method of claim 7, wherein the triggering event occurs when the first award value exceeds a pre-determined amount.

11. The method of claim 7, further comprising deducting a least a portion of the second award value and adding the second award value to a third progressive jackpot.

12. A gaming apparatus comprising:
(A) gaming means for allowing a player to play a game;
(B) display means for displaying a plurality of progressive jackpots, each of the progressive jackpots having a value, the display means mounted in association with the gaming means; and
(C) server means for determining a triggering event, the server means in communication with the gaming means and the display means, the server means being adapted to subtract a portion of at least one of the progressive jackpots and add the portion to at least one of the other progressive jackpots in response to the occurrence of the triggering event.

13. The gaming apparatus of claim 12, wherein the triggering event is the expiration of a time period.

14. The gaming apparatus of claim 12, wherein the triggering event occurs when a value of one of the progressive jackpots exceeds a pre-determined amount.

15. A method of gaming, comprising, not all necessarily in the order shown:
(A) apportioning a percentage of a plurality of wagers on a plurality of gaming devices to fund a first progressive jackpot;
(B) detecting the occurrence of a triggering event;
(C) deducting a first portion of the first progressive jackpot upon the occurrence of the triggering event; and
(D) adding the first portion of the first progressive jackpot to a second progressive jackpot.

16. The method of claim 15, wherein the triggering event is the expiration of a time period.

17. The method of claim 15, wherein the triggering event occurs when the first award value exceeds a pre-determined amount.

18. The method of claim 15, further comprising deducting a second portion of the second progressive jackpot and adding the second portion to a third progressive jackpot.

19. The gaming apparatus of claim 1, wherein the first progressive jackpot is a primary progressive jackpot that is funded from the wager.

20. The gaming apparatus of claim 1, wherein the second progressive jackpot is a secondary progressive jackpot that is funded from the first progressive jackpot.
